(19) United States
(12) Patent Application Publication
(10) Pub. No.: US 2014/0158517 A1
(43) Pub. Date: Jun. 12, 2014

(54) METHODS FOR TREATING PRODUCED WATER

(71) Applicant: Arthur I. Shirley, Hillsborough, NJ (US)

(72) Inventor: Arthur I. Shirley, Hillsborough, NJ (US)

(21) Appl. No.: 13/709,269

(22) Filed: Dec. 10, 2012

(51) Int. Cl. C02F 1/04

(52) U.S. Cl. CPC C02F 1/048
USPC 203/10

(57) ABSTRACT

Produced water from fraccing operations is treated by removing contaminants that are contained therein by evaporating the produced water and feeding the evaporated produced water to a combustion chamber preferably along with an oxygen gas and a hydrocarbon fuel source to separate solids from vapors. The vapors are condensed to produce liquid water and waste gases and the liquid water is recovered for reuse or more environmentally friendly disposal. The waste gases may also be employed in a turbine or expander to produce electricity.

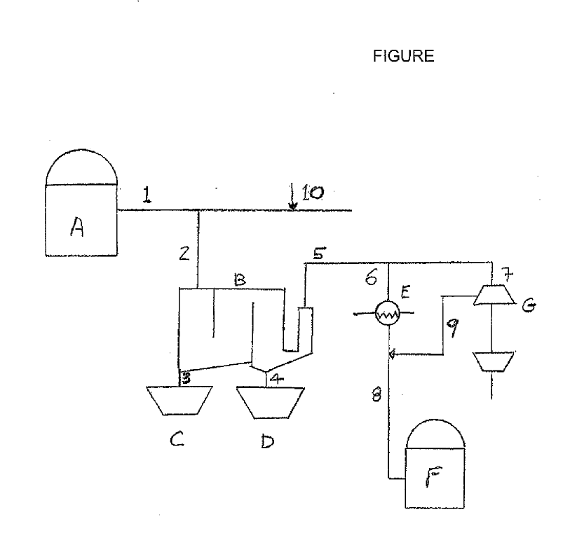

### BACKGROUND OF THE INVENTION

A method for treating produced waters is disclosed. The produced waters from fraccing operations can be treated and reused to minimize their impact on the environment.

During the production of natural gas from shale or other “tight-gas” formations, hydraulic fracturing or “frac” or “fraccing” is used to break up the rock around the wellbore and reduce the resistance to gas flow. The frac technique generally requires injecting into the well large amounts of water pumped to high pressure to create large compressive forces around the well bore.

These forces break the rock creating tiny fissures for gas flow. To aid in the penetration and stability of these fissures, small amounts (1 to 2%) of hydrocarbons, mineral acids and proppants are added to the injected water. Several million gallons of water are injected during each frac job, and much of this water is returned to the surface when the flow is reversed and natural gas is produced from the well.

The produced water is typically brackish with small amounts of the other materials that were injected into the formation. Reuse of these waters can be problematic because of their composition and consequently the produced water must be treated and disposed in surface waters or injected into deep saline aquifers. Disposal on the surface is more difficult due to environmental concerns while injection has been shown to cause everything from contamination of fresh-water aquifers to earthquakes.

The invention can address these concerns and enable better produced water disposal by first atomizing and volatilizing the produced water, incinerating the vapor with additional fuel in an oxygen-containing gas to destroy hydrocarbons and to separate and collect the mineral salts such as ash and running the combustion products through heat exchangers or a gas turbine to generate power or steam and further condensing the water vapor. The condensed water vapor can be reused in other frac jobs while the non-condensable gas can be emitted to the atmosphere without further treatment. This allows the operator of the fraccing operation to reuse the produced waters for future fraccing operations while reducing waste water treatment costs and reducing the costs associated with providing fresh water to the fraccing operations.

### SUMMARY OF THE INVENTION

The invention therefore provides for a method for treating produced water by removing contaminants contained therein comprising the steps:

a) Evaporating the produced water;
b) Feeding said evaporated produced water to a combustion chamber thereby separating solids from vapors;
c) Condensing said vapors to produce liquid water and waste gases; and
d) Recovering said liquid water.

In a further embodiment of the invention, there is disclosed a method for treating produced water by removing contaminants contained therein comprising the steps:

a) Evaporating produced water;
b) Feeding said evaporated produced water to a combustion chamber thereby separating solids from vapors;
c) Condensing said vapors to produce liquid water and waste gases;
d) Feeding said waste gases to a device selected from the group consisting of heat exchangers, expanders and turbines to produce steam and/or electricity; and
e) Recovering said liquid water.

The contaminants that are present in the produced water are various salts, hydrocarbons, mineral acids and particulates.

The produced water is evaporated using the waste heat from the combustion process.

The evaporated produced water is fed to the combustion chamber which is operating at a temperature of 500° C. or greater and at greater than ambient pressure. An oxygen-containing gas and a hydrocarbon fuel source may additionally be fed to the combustion chamber. The oxygen-containing gas preferably contains greater than 21% oxygen and more preferably contains greater than 28% oxygen. The results of the combustion step are that solids such as ash, inorganic solids and salts are separated from vapors.

The waste gases produced in step c) comprise nitrogen, carbon dioxide, oxygen and dilute air compounds. When they are not fed to a steam and/or electricity producing unit operation, these waste gases may be fed from the combustion process to additional operations or may be discharged to the atmosphere.

### BRIEF DESCRIPTION OF THE DRAWINGS

The FIGURE is a schematic of a method for recovering water per the invention.

### DETAILED DESCRIPTION OF THE INVENTION

Produced waters are evaporated or atomized then fed to a combustion chamber preferably along with an oxygen-containing gas and an additional hydrocarbon fuel source as needed. The evaporated/atomized water is combusted to separate solids from vapors and the vapors are condensed to produce liquid water and waste gases.

Turning to the FIGURE, a schematic of an operation for recovering water from produced water is shown. The produced water is typically that which is recovered from a fraccing operation and stored prior to treatment. Produced water typically contains hydrocarbons such as oil and grease, salts, silt and particles, and organic and inorganic compounds. The produced water is typically stored in a large container A and is fed through line 1 where it is evaporated and the evaporated produced water is fed through line 2 to combustor B. The combustion of the produced water is facilitated by the addition of a hydrocarbon fuel and air or an oxygen-containing gas generally having 21% oxygen content and preferably greater than 28% oxygen content through line 10. The produced water is combusted in combustor B and the process of separation of the components present in the produced water begins.

When the produced water is combusted the salts present therein will melt and these are collected in the molten salt recovery basin C through line 3. The solids, silts and particles present in the combusted produced water will be collected in a solids recovery basin D through line 4 from the combustor B.

The produced water that has been combusted is in vapor form and will leave the combustor B through line 5. The vapor will pass through line 6 through a heat exchanger E whereby the vapor is cooled and condensed back to water. This water is recovered through line 8 and fed to storage unit F where it may be stored until further use in fraccing operations or in other operations at the fraccing site.

Part of the vapor may be directed through line 5 to line 7 where it will enter a turbine or expander G. This will produce steam which is fed through line 9 to line 8 where it will join with the condensed water fed to the storage unit F. The turbine or expander will also produce electricity which can be directed to other uses onsite where the produced water is being processed.

The combustion product waste gases can be directed through heat exchangers, expanders or turbines to produce steam and/or electricity. The condensate can be recovered and reused in frac jobs. The further separation of the ash can recover valuable salts. Produced natural gas can be used as the additional fuel for combustion.

While this invention has been described with respect to particular embodiments thereof, it is apparent that numerous other forms and modifications of the invention will be obvious to those skilled in the art. The appended claims in this invention generally should be construed to cover all such obvious forms and modifications which are within the true spirit and scope of the invention.

Having thus described the invention, what I claim is:

1. A method for treating produced water comprising the steps:
a) Evaporating produced water;
b) Feeding said evaporated produced water to a combustion chamber thereby separating solids from vapors;
c) Condensing said vapors to produce liquid water and waste gases; and
d) Recovering said liquid water.

2. The method as claimed in claim 1 wherein said contaminants are selected from the group consisting of salts, hydrocarbons, mineral acids and particulates.

3. The method as claimed in claim 1 wherein said produced water is from a fraccing operation.

4. The method as claimed in claim 1 wherein the produced water is evaporated using waste heat from a combustion process.

5. The method as claimed in claim 1 wherein said combustion process is performed in a combustion chamber.

6. The method as claimed in claim 5 wherein said combustion chamber is operating at a temperature greater than 500° C. and a pressure greater than ambient pressure.

7. The method as claimed in claim 1 wherein a hydrocarbon gas and an oxygen-containing gas are fed to the combustion chamber.

8. The method as claimed in claim 1 wherein said separated solids are selected from the group consisting of ash, inorganic solids and salts.

9. The method as claimed in claim 1 wherein said waste gases are selected from the group consisting of nitrogen, carbon dioxide, oxygen and dilute air compounds.

10. The method as claimed in claim 1 wherein said liquid water is recycled to a fraccing operation.

11. A method for treating produced water comprising the steps:
a) Evaporating produced water;
b) Feeding said evaporated produced water to a combustion chamber thereby separating solids from vapors;
c) Condensing said vapors to produce liquid water and waste gases;
d) Feeding said waste gases to a device selected from the group consisting of heat exchangers, expanders and turbines; and
e) Recovering said liquid water.

12. The method as claimed in claim 11 wherein said contaminants are selected from the group consisting of salts, hydrocarbons, mineral acids and particulates.

13. The method as claimed in claim 11 wherein said produced water is from a fraccing operation.

14. The method as claimed in claim 11 wherein the produced water is evaporated using waste heat from a combustion process.

15. The method as claimed in claim 11 wherein said combustion process is performed in a combustion chamber.

16. The method as claimed in claim 15 wherein said combustion chamber is operating at a temperature greater than 500° C. and a pressure greater than ambient pressure.

17. The method as claimed in claim 11 wherein a hydrocarbon gas and an oxygen-containing gas are fed to the combustion chamber.

18. The method as claimed in claim 11 wherein said separated solids are selected from the group consisting of ash, inorganic solids and salts.

19. The method as claimed in claim 11 wherein said waste gases are selected from the group consisting of nitrogen, carbon dioxide, oxygen and dilute air compounds.

20. The method as claimed in claim 11 wherein said liquid water is recycled to a fraccing operation.

21. The method as claimed in claim 11 wherein said of heat exchangers, expanders and turbines produce steam and/or electricity.
